(19) United States
(12) Patent Application Publication
(10) Pub. No.: US 2004/0161624 A1
(43) Pub. Date: Aug. 19, 2004

(54) Wood panel comprising of bio functional material and method for preparing thereof

(76) Inventors: Jae-Min Hwang, Chungcheongnam-do (KR); Geun-Young Lee, Chungcheongnam-do (KR)

Correspondence Address: SMITH-HILL AND BEDELL, 12670 N W BARNES ROAD, SUITE 104, PORTLAND, OR, 97229

(21) Appl. No.: 10/368,986

(22) Filed: Feb. 18, 2003

(51) Int. Cl. B27K 1/00

(52) U.S. Cl. 428/541

(57) ABSTRACT

The present invention relates to a wood panel comprising one or more bio-functional materials selected from the group consisting of loess, jade, bio stone, and germanium, and a method for preparing the same that enables the preparation of fiberboard or particle board onto which the functional materials are uniformly distributed without processing troubles by spray-coating wood fiber or wood flake with a mixed solution comprising aqueous thermoset resin having a solid content of 60˜70 wt % and the bio-functional materials in the form of fine particulate having an average particle size of 200˜400 mesh. The fiberboard, particle board, decorative ligneous flooring board, etc. have excellent antibacterial and antifungal functions, and at the same time they increase far-infrared radiation efficiency, blood circulation, metabolism, etc., while maintaining the intrinsic properties of the wooden particles.

### BACKGROUND OF THE INVENTION

(a) Field of the Invention

The present invention relates to a wood panel, and particularly, to a wood panel of fiberboard or particle board comprising one or more bio-functional materials selected from the group consisting of loess, jade, bio stone, and germanium, and a method for preparing the same.

(b) Description of the Related Art

In accordance with the depletion of wood resources and restrictions on the use of wood for the protection of the environment, demand for fiberboard and particle board using waste wood, thinned wood, recycled wood, etc. is rapidly increasing, and their uses are also broadly increasing.

Wood is closely connected with human lives in view of its characteristics, as opposed to metals or PVC, and it has been widely used as an environmentally friendly material from ancient times. Recently, fiberboard and particle board have been primarily used as an interior material.

Such fiberboard and particle board are used for personal furniture and implements in our daily lives, for example, for blanket chests, closets, book shelves, various accents, kitchen counters and cabinets, etc.

In particular, Korean-style decorative ligneous flooring boards that are prepared by decoratively processing high-density fiberboard (HDF) from among the fiberboards are suitable for our housing environment, and their demand shows a tendency to gradually replace the previous PVC (polyvinyl chloride) flooring.

In addition, in proportion to improvements of living standards, demand for environmentally-friendly products is expanding and concern about health is increasing day by day, and therefore, studies concerning methods and products capable of improving the function of wooden furniture that is closely connected with human lives have been continuously conducted.

However, the addition of bio-functional materials to fiberboard, particle board, and other materials for floor boards has not been practicably utilized on the grounds that it deteriorates their own intrinsic properties.

Also, the original stone of bio-functional materials consists mostly of a stone component, which is an inorganic substance, and thus if such stone powder is mixed with wood fibers or wood flakes, the difference in their specific gravities in a dried state is large, and thus homogeneous mixing is very difficult. Even when homogeneous mixing is achieved, processing difficulties such as pipe clogging during transfer procedures, abrasion of production components, etc. occur in the actual production line, and such bio-functional materials separate from the wood components due to the difference in specific gravities during drying and other transfer procedures. Furthermore, the bio-functional materials are not uniformly distributed in products, and the final products show layer separation between the boards due to the severe density variation.

Therefore, there is a need for studies concerning methods for preparing boards with improved functions comprising functional materials, and at the same time that are capable of solving separation problems between the wood and functional materials without processing difficulties during the manufacturing process, while maintaining the intrinsic properties of wooden particles in fiberboard, particle board, floor boards, etc.

### SUMMARY OF THE INVENTION

This invention has been made to solve the above-mentioned problems of the prior arts, and it is an object of the invention to provide a wood panel comprising bio-functional material with improved antibacterial and antifungal properties, that is capable of enhancing far-infrared radiation efficiency, blood circulation, and metabolism, and which can be prepared without processing troubles during its manufacturing procedures while maintaining the intrinsic properties of wooden particles when the bio-functional materials are contained in wood panels such as fiberboard, particle board, floor boards, etc., and a method for preparing the same.

It is another object of the invention to provide a wood panel with increased fire resistance and excellent strength, that is capable of maintaining the intrinsic properties of wooden particles without the separation of functional material from the wood, and a method for preparing there same.

In order to achieve the aforementioned objects, the present invention provides a wood panel with bio-functionality comprising a wood substrate comprising

(a) 100 parts by weight of wood fiber or wood flake;

(b) 6˜18 parts by weight of aqueous thermoset resin; and

(c) 1˜12 parts by weight of one or more bio-functional materials selected from the group consisting of loess, jade, bio stone, and germanium having an average particle size of 200˜400 mesh.

Also, the invention provides a method for preparing a wood panel with bio-functionality, comprising

(A) spray-coating (i) 100 parts by weight of wood fiber or wood flake with (ii) a mixed solution comprising a) 6˜18 parts by weight of aqueous thermoset resin solution having a solid content of 60˜70 wt %, and b) 1˜12 parts by weight of one or more bio-functional materials selected from the group consisting of loess, jade, bio stone, and germanium having an average particle size of 200˜400 mesh;

(B) pressing the coating of (A) in a belt press to thereby mold it into a mat; and

(C) heating and pressing the mat of (B) in a hot press under the conditions of a curing temperature of 160˜230° C. and a pressure of 5˜35 kg/cm².

Furthermore, the invention provides a method for preparing a wood panel additionally comprising placing a film having a melamine resin-impregnated pattern on the surface of the hot-pressed mat of (C) and then adhering it thereto by hot pressure.

### DETAILED DESCRIPTION OF THE PREFERRED EMBODIMENTS

This invention will hereafter be described in detail.

The inventors found that as a result of preparing wooden fiberboard or wooden particle board containing bio-functional materials with improved dispersion in water by limiting the particle size of loess, jade, bio stone, germanium, etc., the problems of the prior wood panels with bio-functionality were solved, and in particular, layer separation between wooden particle components and bio-functional materials could be prevented, the intrinsic properties of the wooden particles could be maintained as they were, and no processing difficulties occurred during its manufacturing process, and on the basis of such findings, they completed the invention.

The content of one or more bio-functional materials selected from the group consisting of loess, jade, bio stone, and germanium in the invention is preferably 1˜12 parts by weight with regard to 100 parts by weight of the fiber or flake wooden particles. If said content is less than 1 part by weight, the function of the functional materials is weak, and if it exceeds 12 parts by weight, adhesive performance and strength are reduced.

The bio-functional materials generally have a specific gravity of about 1.5˜3 and if they are pulverized into fine particulates smaller than 200 mesh, their bulk density becomes close to 1. This pulverization enables the mixing of bio-functional materials in a liquid state by raising their dispersion in water, and in particular, it enables the bio-functional materials to be sprayed onto the wood in a mixed state with thermoset resins such as melamine resin, melamine-urea modified resin, urea resin, phenol resin, and phenol-urea modified resin, thereby preventing their separation from the wood. In addition, as they are fed in a liquid state, a quantitative mixing ratio of the wood component, resin, and bio-functional materials can be controlled. The hydration rate of the dispersion solution where such bio-functional materials are dispersed in water is preferably 20 to 95% by weight. The higher hydration rate, the greater the dispersion.

Also, the bio-functional material is a fine particulate having an average particle size of 200˜400 mesh, preferably 250˜350 mesh, and more preferably 325 mesh. The particle size of the bio-functional materials is an essential quality factor in the preparation procedures of functional wood panels.

If the average particle size of the bio-functional materials is smaller than 400 mesh, their oil-absorption ability is increased and thus they can gelate thermoset resin solutions, and floating and clotting with other additives occur when they are mixed with thermoset resins in a mixing tube. Further, when the mixed resins are pumped, the abrasion of production equipment is less, but a constant mixture state is not maintained in a mixing tank, thereby causing a problem to the constant feeding ratio, and consequently depreciation and variation of the properties of the product are affected. Also, if the average particle size is bigger than 200 mesh, it is difficult to disperse them in water, and even if they are dispersed, facility problems such as clogging of transfer lines, abrasion of transfer pumps, etc. readily occur, and it is difficult to uniformly distribute them in a molded body.

Also, if the bio-functional materials are dispersed in water with a concentration of about 20˜30% by weight (hydration rate=70 to 80 wt %), in spite of continuous agitation, the particles sink to the bottom, and at the same time, if the average particle size of the bio-functional particles is larger than 200 mesh, the resins that are added at a certain amount within each weighing vessel sink to the bottom of the mixing tank and thus the pipe that is connected with a mixer may clog. Further, even if clogging does not occur, the mixed resins cause abrasion to pumps because of the roughness of the particles, and they cannot be coated at a uniform ratio due to the numerous particles that sink to the bottom during pumping, and consequently the depreciation and variation of the properties occur.

The bio-functional materials having the average particle size of 200˜400 mesh are prepared in a liquid state by dispersing them in water so that their concentration becomes 5 to 80% by weight, preferably 10˜30% by weight. In this process, if large particles are partially contained therein, they may cause severe problems to the quantitative transfer pump, and accordingly, they need to be removed by use of a separate vibrating screen. Ordinary mixers can be used to disperse the bio-functional materials in water, and for a short dispersion time, a homo mixer, homogenizer, dispersion device for coating, sand mill, etc. can be used.

As the bio-functional materials are inorganic substances, they increase the fire resistance of the wood panel to be prepared. In particular, bio-functional materials containing crystal water such as loess exhibit excellent fire resistance. Also, if aqueous thermoset resins are mixed with flame retardants such as dicyandiamide and then sprayed onto the wooden particles, they give rise to synergic effects of fire resistance together with the bio-functional materials and thus the wood substrate may exhibit the properties of at least class II nonflammability, and if a coated layer containing a melamine flame retardant resin is coated onto the surface of the wood panel, the loess confers more excellent flame retardancy to the surface and enables the surface to exhibit the properties of at least class I nonflammability.

The aqueous thermoset resin of the invention is selected from the group consisting of melamine resin, melamine-urea modified resin, urea resin, phenol resin, and phenol-urea modified resin, and it is preferably added in an amount of 6˜18 parts by weight of resin solution with regard to 100 parts by weight of wood fiber or wood flake. In this process, one or more bio-functional materials selected from the group consisting of loess, jade, bio stone, and germanium in an aqueous solution can be combined therewith.

The solid content of the aqueous thermoset resin is preferably 60˜70% by weight. If the content is less than 60% by weight, the addition amount of the bio-functional materials is comparatively decreased and thus the strength of the board may be reduced, and if it exceeds 70% by weight, the preservability of the binder itself becomes problematic and its dispersion ability is reduced and thus it is not smoothly dispersed when it is added to the wood.

The wood fiber or wood flake of the invention is prepared by re-processing the same kind of wood into particles of small units and to eliminate foreign materials other than the wood, and by classifying the particles into equal sizes to improve the quality of products. In the case of fiberboard or floor boards, the wood chips are dry-refined and then secondarily processed into wood fiber, and in the case of particle board, they are subjected to a particle process and are processed into small wood flakes of about 1˜5 mm (small particles).

In addition, the wood fiber or wood flakes may be coated with a mixed solution of the bio-functional materials and aqueous thermoset resin solution in a sol state with a milk-like consistency, as follows. In the case of MDF (medium density fiberboard) consisting of wood fiber, the wood fiber can be coated with a mixed solution of the bio-functional materials, thermoset resin, and water by spraying it with an adhesive pump through a hose onto the wood chips with a spray nozzle that is inserted into a hole of a blow pipe that transfers the wood chips from a refiner (facility for pulverizing the wood chips into fiber) to a drier, using pump pressure (10˜20 kg/cm)₂. On the other hand, in the case of PB (particle board) consisting of flakes, it can be coated by spraying it onto the wood chips using pump pressure through a spray nozzle that is inserted into a hole of the upper portion of the input part of a bicylinder coater.

A resin adhesive rate, which is a mixing ratio of the thermoset resin with regard to the wood, varies slightly according to the kind of wooden products to be prepared, but it is preferably 14˜18 wt % in the high density functional fiberboard for floor boards, 10˜13 wt % in the ordinary medium density functional fiberboard, and 8˜12 wt % in the functional particle board.

If the resin adhesive rate is low, the strength of the fiberboard may be reduced, and if it is too high, this causes not only increased cost in manufacture and but also a lumping phenomenon between the wooden particles and resin which is expressed in the form of spots at the surface of the board, severe damaging the quality.

Further, if necessary, the thermoset resin solution of the invention may additionally comprise a flame retardant, wax emulsion, curing agent, etc.

The flame retardant confers flame retardancy to the wood panel, and various flame retardants such as dicyandiamide, a phosphor flame retardant, a halogen flame retardant, etc. can be used in accordance with compatibility with the types of the thermoset resins. The flame retardant is preferably contained in the thermoset resin solution in an amount of 0.01 to 10% by weight.

The wax emulsion may be added for water resistance and smooth transfer, and it is preferably contained in an amount of 3˜5% by weight with regard to the resin component of the aqueous thermoset resin solution.

The curing agent is used to increase the production rate by shortening the curing time of the thermoset resin, and it is preferably contained in an amount of 2˜4% by weight with regard to the resin component of the aqueous thermoset resin solution. Examples thereof include ammonium chloride and ammonium sulfate.

The wood panel of the invention is prepared by spraying the wood fiber or wood flake with a mixed solution of the bio-functional material and aqueous thermoset resin, pressing this coating in a belt press to thereby pre-mold it into a certain mat state, and then by molding it by heat and pressure in a hot press.

The mat having pre-molded mixture of the bio-functional material, aqueous thermoset resin, and wood fiber or wood flake in a certain form contains a certain amount of air and moisture, which can solve a breakage problem caused by excessive pressure during the hot press process after the pre-molding procedure.

The final hydration rate of the molded mat of the mixture of the bio-functional material, aqueous thermoset resin, and wood fiber or wood flake that passes through the pre-molding procedure may show a little difference with respect to the type and thickness of the boards.

The hydration rate is determined in the resin coating procedure and the drying procedure of the wood flake or the coating, and it enables heat to be smoothly transmitted to the core of the board when the wood particles, thermoset resin, and functional material are mutually adhered. The moisture is evaporated from the board with the heat. The hydration rate before being pre-molded into a mat is preferably 9˜15% by weight. If the hydration rate is less than 9% by weight, heat is not transmitted well during molding, heating, or pressing and thus the curing and compression effects of the resin are not well obtained, and if it exceeds 15% by weight, excessive vapor pressure occurs within the board and thus the adhesion may be poor.

The curing temperature is preferably 160˜230° C. when melamine resin, melamine-urea modified resin, urea resin, phenol resin, and phenol-urea modified resin are used. The curing temperature is one of the most important factors in the preparation of the board, as it determines the strength and the preparation time of the board, and it is different according to the type, thickness, etc. thereof. Also, if the curing temperature is less than 160° C., the curing of the resin is not complete and thus the strength may be reduced, and if it exceeds 230° C., premature curing occurs and thus the strength is reduced, and an excessive increase in temperature is a fire hazard.

During the hot press procedure, the pressure condition, which is an important factor as is the curing temperature, is 5˜35 kg/cm², and it is preferable to regulate the vapor pressure generated during the hot press procedure within the said range so than it can be completely discharged via the side of the board by repeated application of pressure. If the vapor pressure remains inside-the board after the hot press procedure, the pressure causes the board to break up the moment the pressure is released. That is, in the case that the adhesion strength of the thermoset resin inside the board is lower than the remaining vapor pressure, such phenomenon occurs.

Therefore, so as to prevent such problems, the mixing ratio of the functional material and thermoset resin, the hydration rate of the mat, the curing temperature and pressure during the hot pressure process, etc. should be mutually suitably maintained.

In the wood panel of the invention, shape papers such as a melamine resin impregnated film may be additionally adhered onto the wood panel substrate of the fiber board or particle board prepared in the above.

The melamine impregnated film refers to a melamine resin that is impregnated onto special paper, and it is used by adhering the impregnated film on which patterns are printed to the original MDF or FB board that is used for kitchen furniture, closets, tables, desks, book shelves, etc. The adhesion can be carried out by combining the impregnated film with the original MDF or PB board, and then by heating and pressing it in a separate hot press.

The wood panel of the invention has various effects such as cell activation, body thermalization, acceleration of blood circulation, perspiration, acceleration of metabolic function, pain relief, antibacterial, anti-moisture, maintenance of the freshness of foods, maturation effects, deodorization, etc. according to the type of one or more bio-functional materials that are selected from the group consisting of loess, jade, bio stone, and germanium, and doubles quality competition by improving the quality of the prior functional boards. In particular, when the functional fiber board of the invention is applied to a Korean-style floor board, its far-infrared radiation is increased and thus the acceleration of metabolism and blood circulation is activated, and it can also provide effects such as such as uniform heating, the reduction of heating time, and the retrenchment of energy during the manufacturing process by virtue of the heat transmission property of far-infrared.

This invention will be described in more detail with reference to the following examples and comparative examples. However, the examples are provided solely to illustrate the present invention, and the invention should not be construed to be limited thereto.

### EXAMPLES

### Example 1

A mixed solution of 13 parts by weight of melamine resin having a solid content of 70 wt %, 5 parts by weight of loess particulate having an average particle size of 325 mesh dispersed in water (hydration rate of dispersion solution=80 wt %), and as other additives, 0.2 parts by weight of wax emulsion and 0.1 parts by weight of ammonium sulfate curing agent was spray-coated in a liquid state onto 100 parts by weight of wood fiber that was prepared by dry-refining wood chips. This coating was spread by coating it onto a belt that was continuously moving and was pre-pressurized in a continuous driving pre-pressurization press, and then it was subjected to pressurization and depressurization in a hot press at a curing temperature of 230° C. and a pressure of 15 kg/cm² for 3 min. to thereby prepare a functional fiber board having a density of 849 kg/m³ and a thickness of 12 mm.

### Example 2

A functional fiber board was prepared in the same manner as in Example 1, except that the functional material of Example 1 was replaced by jade.

### Example 3

A functional fiber board was prepared in the same manner as in Example 1, except that the functional material of Example 1 was replaced by bio stone.

### Example 4

A functional fiber board was prepared in the same manner as in Example 1, except that the functional material of Example 1 was replaced by germanium.

### Example 5

A functional fiber board was prepared in the same manner as in Example 1, except that the functional material of Example 1 was replaced by a mixture of loess and jade.

### Example 6

A functional fiber board was prepared in the same manner as in Example 1, except that the functional material of Example 1 was replaced by a mixture of bio stone and jade.

### Example 7

A functional fiber board having a density of 950 kg/m³ and a thickness of 7.5 mm was prepared in the same manner as in Example 1, except that the pressurization pressure of 30 kg/cm² was applied.

### Example 8

A film having a melamine-impregnated shape was hot-pressed onto the functional board prepared in Example 7 at a pressure of 30 kg/cm², at a curing temperature of 190° C. for 25 sec to thereby prepare a functional board in the form of a Korean-style floor board.

### Example 9

A mixed solution of 13 parts by weight of phenol-urea modified resin having a solid content of 70 wt %, 5 parts by weight of loess particulate having an average particle size of 325 mesh dispersed in water (hydration rate of dispersion solution=80 wt %), and as other additives, 0.2 parts by weight of wax emulsion and 0.1 parts by weight of dicyandiamide flame retardant was spray-coated in a liquid state onto 100 parts by weight of wood flakes having a particle size of 1 to 5 mm that was completely dried. The hydration rate of this coating was 15% by weight. The coating was spread by coating it onto a belt that was continuously moving and was pre-pressurized in a continuous driving pre-pressurization press, and then it was subjected to pressurization and depressurization in a hot press at a curing temperature of 230° C. and a pressure of 15 kg/cm² for 3 min. to thereby prepare a functional wood particle board having a density of 755 kg/m³ and a thickness of 12 mm.

### Comparative Examples

### Comparative Example 1

A mixed solution of 13 parts by weight of melamine resin having a solid content of 70 wt %, and as other additives, 0.2 parts by weight of wax emulsion and 0.1 parts by weight of ammonium sulfate curing agent was spray-coated in a liquid state onto 100 parts by weight of wood fiber that was prepared from wood chips. The obtained product was dried in a moving drier so that its hydration rate became 11% by weight, and then it was pre-pressurized using a pre-pressurization press (belt press) and was subjected to pressurization and depressurization in a hot press at a curing temperature of 230° C. and a pressure of 15 kg/cm² for 3 min. to thereby prepare a fiber board having a density of 849 kg/m³ and a thickness of 12 mm.

### Comparative Example 2

A fiber board having a density of 950 kg/m³ and a thickness of 7.5 mm was prepared in the same manner as in Comparative Example 1, except that the pressurization pressure of 30 kg/cm² was applied.

### Comparative Example 3

A melamine-impregnated film shape was hot-pressed onto the functional board prepared in Comparative Example 2 at a pressure of 30 kg/cm², at a curing temperature of 190° C. for 25 sec to thereby prepare a functional board in the form of a Korean-style floor board.

### Comparative Example 4

A functional fiber board was prepared in the same manner as in Example 1, except that a functional material having an average particle size of 100 μm, which is bigger than 200 mesh, was used.

### Comparative Example 5

A functional fiber board was prepared in the same manner as in Example 1, except that the functional material having an average particle size of 10 μm, which is smaller than 400 mesh, was used.

The properties of the functional boards prepared in Examples 1 to 9 and the ordinary boards prepared in Comparative Examples 1 to 5 were determined, and the results were shown in Table 1 below.

TABLE 1

| | | | Expansion | Far-infrared |
|---|---|---|---|---|
| | Density | Peel Strength | Rate in | Radiation Rate |
| Category | (kg/m³) | (kgf/cm²) | Water (%) | (%) |
| Example 1 | 849 | 10.0 | 4.1 | 90.7 |
| Example 2 | 862 | 9.9 | 3.6 | 90.6 |
| Example 3 | 859 | 12.2 | 3.0 | 90.9 |
| Example 4 | 859 | 8.5 | 3.1 | 90.5 |
| Example 5 | 846 | 8.8 | 3.5 | 90.3 |
| Example 6 | 860 | 10.2 | 3.7 | 90.2 |
| Example 7 | 950 | 16.8 | 3.5 | 90.7 |
| Example 8 | 952 | 17.2 | 0.1 | 89.5 |
| Example 9 | 755 | 8.5 | 3.0 | 91.5 |
| Comparative Ex. 1 | 849 | 8.1 | 4.1 | 70.3 |
| Comparative Ex. 2 | 950 | 15.0 | 3.8 | 70.1 |
| Comparative Ex. 3 | 955 | 15.5 | 0.2 | 69.5 |
| Comparative Ex. 4 | 850 | 7.5 | 4.2 | 90.3 |
| Comparative Ex. 5 | 845 | 7.9 | 4.3 | 90.2 |

From Table 1 above, it can be seen that the functional boards of Examples 1 to 6 where the functional material was added were significantly better in peel strength, expansion rate in water, and far-infrared radiation rate than the boards of Comparative Example 1 where no functional material was added, under similar density and process conditions.

Also, it can be seen that the functional board of Example 7 having a different density and thickness was excellent in strength and far-infrared radiation rate as compared with the board of Comparative Example 2 where no functional material was added.

Also, in Comparative Example 3 and Example 8 where Korean-style floor boards were prepared, the floor board of Example 8 where the functional material was added exhibited excellent results in peel strength and far-infrared radiation rate as compared with Comparative Example 3 where no functional material was added.

Also, during the procedures for preparation of Comparative Examples 4 and 5 where the functional material had a different particle size, the particles of Comparative Example 4 sank and thus caused a problem with facility abrasion and quantitative feeding ratio, and in Comparative Example 5, floating and clotting phenomena occurred, whereby a constant feeding ratio was not maintained and consequently it can be seen that the properties such as peel strength and expansion rate in water were remarkably reduced as compared with Example 1 with the functional material having a particle size of 200˜400 mesh.

Also, when the wood flake was used instead of the wood fiber to prepare the wood particle board, as shown in Example 9, the same results as obtained when the wood fiber board was used were obtained.

Consequently, it can be seen that all of the functional boards prepared by addition of one or more functional materials selected from the group consisting of loess, jade, bio stone, and germanium having an average particle size of 200˜400 mesh exhibited excellent results under every condition in comparison with the ordinary boards.

The method of the invention enables the fiberboard and particle board comprising the bio-functional material to be prepared smoothly without processing troubles such as the separation of layers during the manufacturing procedures, pipe clogging during the transfer procedures, the abrasion of production facilities, etc., and it also brings about effects such as uniform heating, the reduction of heating time, and the retrenchment of energy by virtue of the heat transmission of far-infrared. Also, the fiber board comprising the bio-functional materials prepared by the method of the invention can solve problems such as decay by fungi or bacteria due to long-term use that occur in the prior fiber boards or particle boards, the reduction and modification of strength by humidity, etc., and functions such as cell activation, body thermalization, acceleration of blood circulation, perspiration, acceleration of metabolic function, pain relief, antibacterial, anti-moisture, maintenance of the freshness of foods, maturation effects, deodorization, flame retardancy, etc are conferred. In addition, when the functional fiber board of the invention is applied to a Korean-style floor board, its far-infrared radiation is increased in comparison with the prior floor boards, and thus it can provide acceleration and activation of metabolism and blood circulation.

What is claimed is:

1. A wood panel with bio-functionality comprising a wood substrate comprising
(a) 100 parts by weight of wood fiber or wood flake;
(b) 6˜18 parts by weight of aqueous thermoset resin; and
(c) 1˜12 parts by weight of one or more bio-functional materials selected from the group consisting of loess, jade, bio stone, and germanium having an average particle size of 200˜400 mesh.

2. The wood panel of claim 1 wherein said wood panel is fiberboard.

3. The wood panel of claim 1 wherein said wood panel is particle board.

4. The wood panel of claim 1 wherein the aqueous thermoset resin of (b) is selected from the group consisting of melamine resin, melamine-urea modified resin, urea resin, phenol resin, and phenol-urea modified resin,

5. The wood panel of claim 1 wherein a film having a melamine resin-impregnated pattern on the surface is additionally adhered onto the surface of the wood substrate.

6. A method for preparing of a wood panel with bio-functionality, comprising
(A) spray-coating (i) 100 parts by weight of wood fiber or wood flake with (ii) a mixed solution comprising a) 6˜18 parts by weight of aqueous thermoset resin solution having a solid content of 60˜70 wt %, and b) 1˜12 parts by weight of one or more bio-functional materials selected from the group consisting of loess, jade, bio stone, and germanium having an average particle size of 200˜400 mesh;
(B) pressing the coating of (A) in a belt press to thereby mold it into a mat; and
(C) heating and pressing the mat of (B) in a hot press under the conditions of a curing temperature of 160˜230° C. and a pressure of 5˜35 kg/cd.

7. The method for preparing of wood panel of claim 6 further comprising (D) placing a film having a melamine resin-impregnated pattern on the surface of the hot-pressed mat of (C) and then adhering it thereto by hot pressure.

8. The method for preparing of wood panel of claim 6 wherein the mixed solution of (A) further comprises one or more additives selected from the group consisting of a flame retardant, wax emulsion, and curing agent.

9. The wood panel prepared by the method described in claim 6.

10. The floor board prepared by the method described in claim 7.
